(19) United States
(12) Patent Application Publication
(10) Pub. No.: US 2015/0333910 A1
(43) Pub. Date: Nov. 19, 2015

(54) SYSTEMS, METHODS, AND APPARATUSES FOR SECURELY ACCESSING USER ACCOUNTS

(71) Applicants: Dylan Kirdahy, Staten Island, NY (US); Jun Qi Ou, Staten Island, NY (US)

(72) Inventors: Dylan Kirdahy, Staten Island, NY (US); Jun Qi Ou, Staten Island, NY (US)

(21) Appl. No.: 14/715,571

(22) Filed: May 18, 2015

Related U.S. Application Data
(60) Provisional application No. 61/994,884, filed on May 17, 2014.

(51) Int. Cl. H04L 9/32

(52) U.S. Cl. CPC H04L 9/3231; H04L 9/3234

(57) ABSTRACT

The systems, methods, and apparatuses of the present disclosure quickly and securely populate account information fields of an account using biometric information, such as fingerprint information. A portable electronic apparatus of the present disclosure includes memory that stores first fingerprint information in association with account information of an account that can be presented by another electronic device through a website or an application running on the other electronic device. The portable electronic apparatus also includes a fingerprint scanner that scans a fingerprint to obtain second fingerprint information, an interface that interfaces with data input interface, such as a keyboard interface, of the other electronic device, and a processor that compares the first fingerprint information with the second fingerprint information, and, if the fingerprint information matches, populates the account information field of the account with the account information via the data input interface of the other electronic device.

### BACKGROUND

1. Technical Field

The present disclosure relates to securely accessing user accounts on electronic devices. In particular, the present disclosure relates to a portable personal security device for quickly and securely providing account information to access a user account.

2. Background of Related Art

Today's users of electronic devices must remember multiple usernames and lengthy passwords to effectively protect access to their electronic devices, the applications running on those electronic devices, and user accounts accessible through a website. Often users forget usernames and passwords and have only a few similar and weak passwords. And there are security risks associated with manually entering usernames and passwords, or saving usernames and passwords on the electronic device. Many electronic devices, such as laptop computers, smartphones, and tablets, integrate a fingerprint scanner or other type of biometric scanner to allow a user to access the electronic device or applications running on the electronic device without having to manually input a username and password. However, electronic devices that include fingerprint scanners must be preconfigured by the user before they can use the fingerprint scanner to access the electronic devices, applications running on the electronic device, or password-protected webpages displayed in a browser of the electronic devices.

### SUMMARY

The systems, methods, and apparatuses of the present disclosure allow a user to store account information, e.g., usernames, passwords, and login information, securely on a small electronic device, e.g., a memory drive, while minimizing security risks. The systems, methods, and apparatuses of the present disclosure also allow a user to quickly and securely log into any account, website, or application using the user's fingerprint as their username, password, or both username and password.

According to the present disclosure, a user may record various passwords and usernames for various accounts within a small electronic security device, such as a flash memory drive, with a connector for interfacing with a personal computer or other device. The small electronic security device, such as a flash memory device, as described in the present disclosure, includes various buttons to toggle through various accounts containing usernames, passwords, and other account information. The flash memory drive consistent with the present disclosure further comprises a fingerprint scanner or other biometric acquiring device. A user may place or swipe a finger on the fingerprint scanner to scan the fingerprint. If the scanned fingerprint matches a fingerprint recorded in the flash memory drive, the flash memory drive may load password and username information for the chosen account to another electronic device or other device, the information being entered as if typed on an external keyboard, connected through, for example, a USB connector.

### BRIEF DESCRIPTION OF THE DRAWINGS

Various aspects of the present disclosure are described hereinbelow with reference to the drawings, which are incorporated in and constitute a part of this specification, wherein:

FIG. 1A is a perspective view of a system according to embodiments of the present disclosure;

FIG. 1B is a schematic diagram of the system of FIG. 1A;

FIG. 2 is a schematic diagram of the electronic security device according to embodiments of the present disclosure;

FIG. 3A is a top view of the electronic security device according to embodiments of the present disclosure;

FIG. 3B is a top view of the electronic security device according to embodiments of the present disclosure with an exemplary account designation display in auto login mode;

FIG. 3C is a top view of the electronic security device according to embodiments of the present disclosure with an exemplary account designation display toggled into a subsequent account designation in auto login mode;

FIG. 4A is a top view of the electronic security device according to embodiments of the present disclosure with an exemplary fingerprint placement in auto login mode;

FIG. 4B is a top view of the electronic security device according to embodiments of the present disclosure with an exemplary login type display in auto login mode;

FIG. 4C is a top view of the electronic security device according to embodiments of the present disclosure with an exemplary login type display with an exemplary fingerprint placement in auto login mode;

FIG. 5A is a top view of the electronic security device according to embodiments of the present disclosure with an exemplary display of account type login status;

FIG. 5B is a top view of the electronic security device according to embodiments of the present disclosure with an exemplary display of account name login status;

FIG. 5C is a top view of the electronic security device according to embodiments of the present disclosure with an exemplary display of a successful login;

FIG. 6A is a top view of the electronic security device according to embodiments of the present disclosure with an exemplary display of a failed login;

FIG. 6B is a top view of the electronic security device according to embodiments of the present disclosure with an exemplary display of account lockout;

FIG. 6C is a top view of the electronic security device according to embodiments of the present disclosure with an exemplary resetting display;

FIG. 7A is a top view of the electronic security device according to embodiments of the present disclosure with an exemplary login type display in password login mode;

FIG. 7B is a top view of the electronic security device according to embodiments of the present disclosure with an exemplary login type display in password login mode;

FIG. 8A is a top view of the electronic security device according to embodiments of the present disclosure with an exemplary first time setup display;

FIG. 8B is a top view of the electronic security device according to embodiments of the present disclosure with an exemplary pending installation display;

FIG. 9A is a top view of the electronic security device according to embodiments of the present disclosure with an exemplary data syncing display;

FIG. 9B is a top view of the electronic security device according to embodiments of the present disclosure with an exemplary removal display;

FIG. 9C is a top view of the electronic security device according to embodiments of the present disclosure with an exemplary computer access menu display; and

FIG. 10 is a flow diagram of a method to gain access to saved username and password information according to embodiments of the present disclosure.

### DETAILED DESCRIPTION

Embodiments of the present disclosure are now described in detail with reference to the drawings in which like reference numerals designate identical or corresponding elements in each of the several views.

This disclosure relates generally to an account login apparatus allowing users to securely save password and username information, protect such information by placing or swiping a fingerprint or other biometric information, and uploading such information to an external electronic device to log the user into an ASCII-based password-protected account, such as gmail, facebook, or a bank account presented by the external electronic device.

In an embodiment of the present disclosure, the apparatus screen illuminates when and interface or a connector, such as a USB connector, is connected with an external electronic device, indicating that the apparatus is ready to use. A user may navigate, using the external electronic device connected to the apparatus, to an ASCII login screen in an application, website, or other type of login interface. Once there, the user may use the apparatus to retrieve and upload username and/or password information from the apparatus.

In the home screen 428, login mode 424 is selectable to determine if the user would like to input a username, a password, or both from information saved on the apparatus. Additionally, on the home screen, accounts may be selected by toggling through a list of account names or “Quick Fingers” may be chosen. If “Quick Fingers” is selected, a user may input biometric data, such as fingerprint data, on a biometric device, such as a fingerprint scanner input through swiping a finger. If the item of biometric data, e.g. the print of a specific finger, matches the saved biometric data for the account being accessed, the apparatus recognizes the match, decrypts the saved login information, and inputs the login information into the ASCII login fields on the external electronic device and submits the data to the application, website, or other graphical user interface by transmitting an enter or return command via the keyboard interface of the external electronic device.

In a further embodiment of the present disclosure, rather than choose “Quick Fingers,” a user may choose an account from a list of accounts by scrolling through the list with two buttons. When an account is selected, a finger is placed or swiped on a fingerprint scanner. If the swiped or placed fingerprint matches fingerprint information saved on the portable apparatus and associated with the chosen account, the apparatus decrypts saved login information using, for example, a pair of password-less RSA keys and PGP protocol, and uploads the login information into the ASCII login fields in a series on the external electronic device as a string of external keyboard character inputs. The input of account information, e.g., login information, may occur by transferring through a connector or interface, e.g., a USB connector or interface, which may be a wireless interface, the username character string, then a tab character, the password character string, and finally an enter character.

In another embodiment of the present disclosure, the apparatus accepts login data from an external electronic device. After a user has entered account information into an ASCII account interface on an external electronic device through means other than using the apparatus described in the present disclosure, e.g. through a keyboard, and while the apparatus is connected to the external electronic device, a user may be prompted, via a display screen on the apparatus, to choose whether to import the account information entered to the apparatus's memory. If the user selects yes, the information is imported and saved. The user may then be prompted to place or swipe a finger on the fingerprint scanner to input a fingerprint for association with the imported account information.

In a further embodiment of the present disclosure, the apparatus is powered prior to connecting the apparatus to an external electronic device. The apparatus may be power through an alternative source. For instance, the apparatus may be powered with a battery or other power source. Furthermore, the apparatus may not require a physical connection to interact with an external electronic device. The apparatus may communicate with the external electronic device through a wireless connection, such a Bluetooth.

In another embodiment of the present disclosure, the apparatus includes colored LED indicators, such a red and green LEDs, to indicate certain occurrences. For example, when the apparatus is writing to an external device or receiving data from an external device, a red LED may illuminate indicating that the apparatus should not be removed from the external electronic device. When the apparatus is not writing or receiving data, a green LED may illuminate indicating the apparatus may be removed from the external electronic device.

In a further embodiment of the present disclosure, the apparatus includes a sound producing device, such as a buzzer or other speaker. The sound producing device may be configured to produce a sound to give the user feedback and indicate certain occurrences. For example, when there has been a successful login, the sound producing device may create a buzzing sound to indicate the successful login.

In yet another embodiment of the present disclosure, instead of associating login information with fingerprint data, the apparatus receives and associates login information with voice biometrics. The apparatus prompts a user to verbally input a word or command to be associated with account or login information. In order to access the account or login information, a user may need to verbal input the same word or command or say something in the same voice previously used to save information within the apparatus.

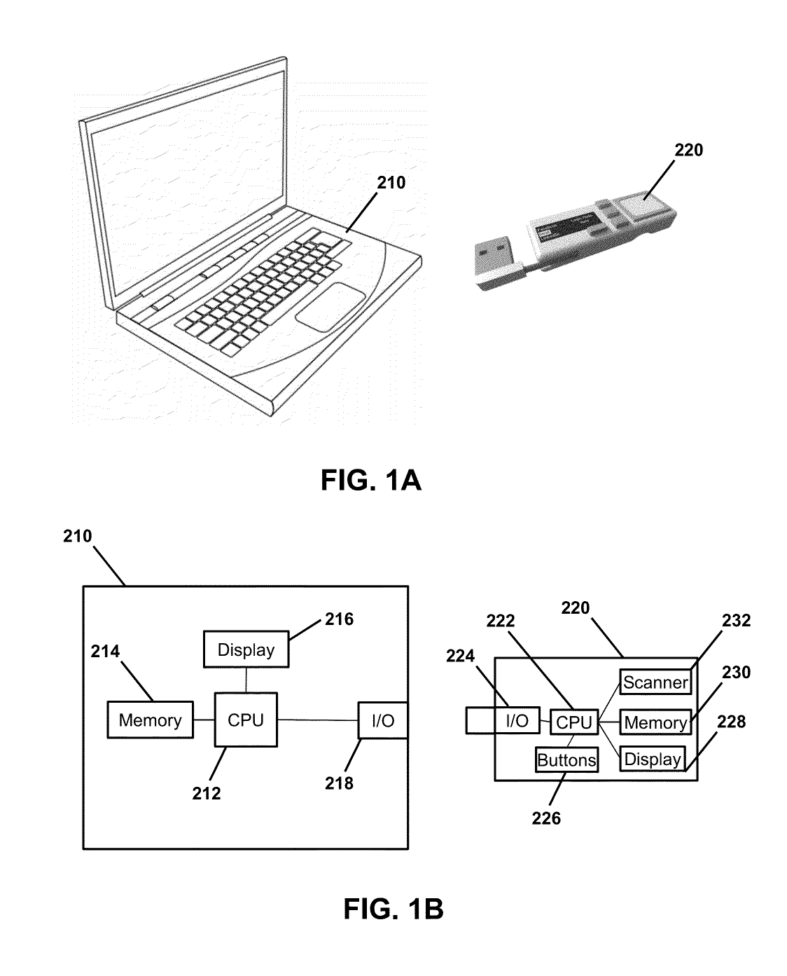

In reference to FIGS. 1A and 1B, there is shown a system level view of a system of the present disclosure. FIG. 1A shows a perspective view of an external electronic device 210 and portable electronic apparatus 220 in accordance with the present disclosure. FIG. 1B shows external electronic device 210 and a portable electronic apparatus 220 in accordance with the present disclosure in schematic view. External electronic device 210 includes memory 214, such as RAM, configure to save information, including application data, an input/output (I/O) device 218 configured to connect to I/O device 224, e.g., the keyboard interface, of portable electronic apparatus 220 and allow communication therewith, display 216 configured to display a graphical user interface (not shown), and a Control Process Unit (CPU) 212 configured to direct information between I/O device 218 and memory 214 as well as process data from I/O device 218 and Memory 214.

Portable electronic apparatus 220 includes CPU 222 connected in association with I/O device 224, Buttons 226, Scanner 232, such as a fingerprint scanner, memory 230, e.g. flash memory, and display 228. CPU 222 may receive and process information from Scanner 232, as, for example, capacitive data or image data, from Buttons 226, as user inputs, from Memory 230, and from external electronic device 210 through I/O device 224. CPU 222 may further transfer data to display 228 from memory 230, which is configured to store fingerprint, username, password, and other account information.

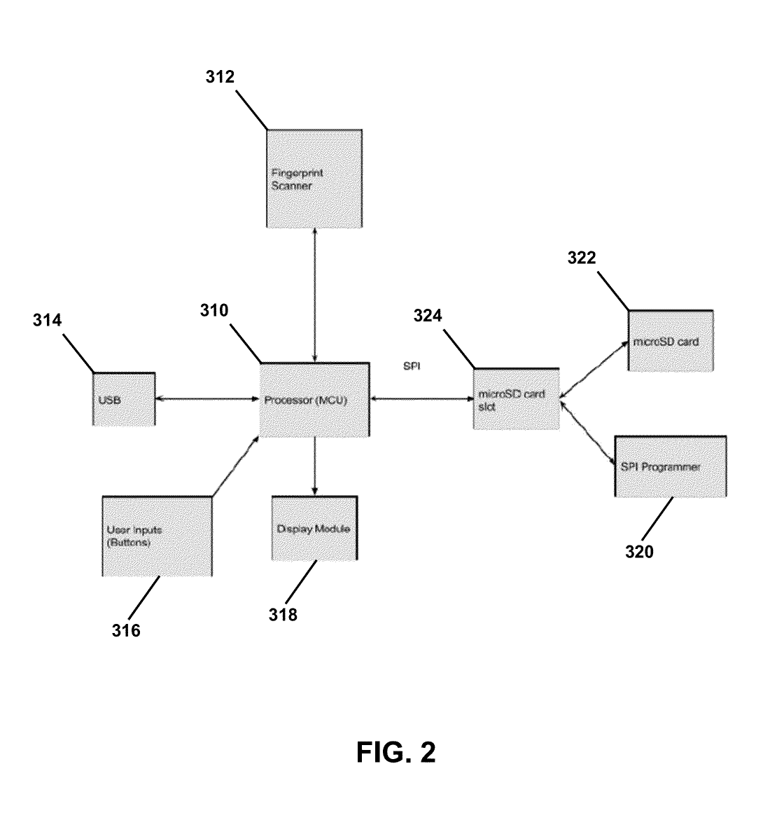

Referring to FIG. 2, there is shown a block diagram showing the association of potential components in accordance with the present disclosure. The component block diagram includes Processor (MCU) configured to receive input information from User Inputs (Buttons), USB, microSD card slot, through microSD card slot, and Fingerprint Scanner. In turn, Processor (MCU) is configured to output information to USB, Display Module, and MicroSD card slot, through microSD card slot. When connected to a USB slot of an external electronic device, the USB receives power from the external electronic device 210 to power Processor (MCU). When powered, Processor (MCU) prompts a user through Display Module, the user inputs selections through User Inputs (Buttons) and through Fingerprint Scanner. Processor queries microSD card through microSD card slot and compares information from microSD card with User Inputs (Buttons) and Fingerprint Scanner information. If input information matches microSD card information, Processor outputs information as keyboard text through USB to external electronic device.

Further referring to FIG. 2, when recording usernames, passwords, and fingerprint information, Processor 310 receives information from User Inputs 316, Fingerprint Scanner 312, and external electronic device 210 through USB 314. Processor 310 transmits data to SPI programmer 320 through microSD card slot 324, and SPI programmer 320 programs microSD card 322 through microSD card slot 324 in order load initial software, save account information for future comparison, save fingerprint or biometric data, and save encryption data.

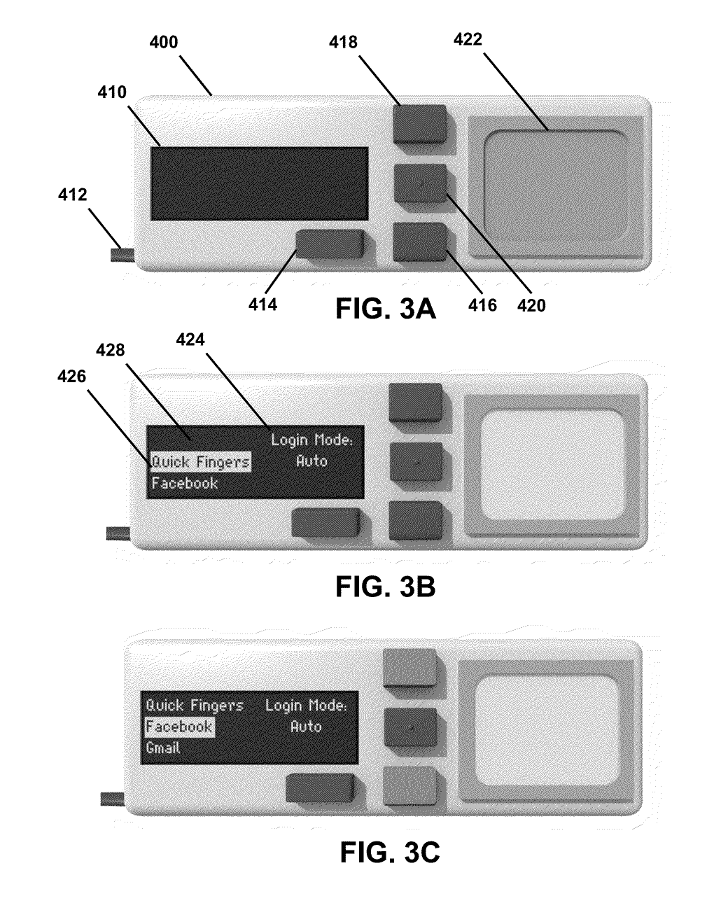

FIG. 3A shows an unpowered apparatus 400 comprising login mode toggle button 414, position toggle buttons 416, 418, select button 420, fingerprint scanner 422, display screen 410, and connector 412. FIG. 3B shows powered apparatus 400, powered through a connected external electronic device, internal battery supply or other power source, displaying home screen 428 with the device in Auto Login Mode. A user may press toggle buttons 416, 418 to toggle up and down through the list of accounts 426, including, for example, Facebook, Gmail, etc. as shown on home screen 428. FIG. 3C shows an updated display after toggling from “Quick Fingers” to “Facebook”

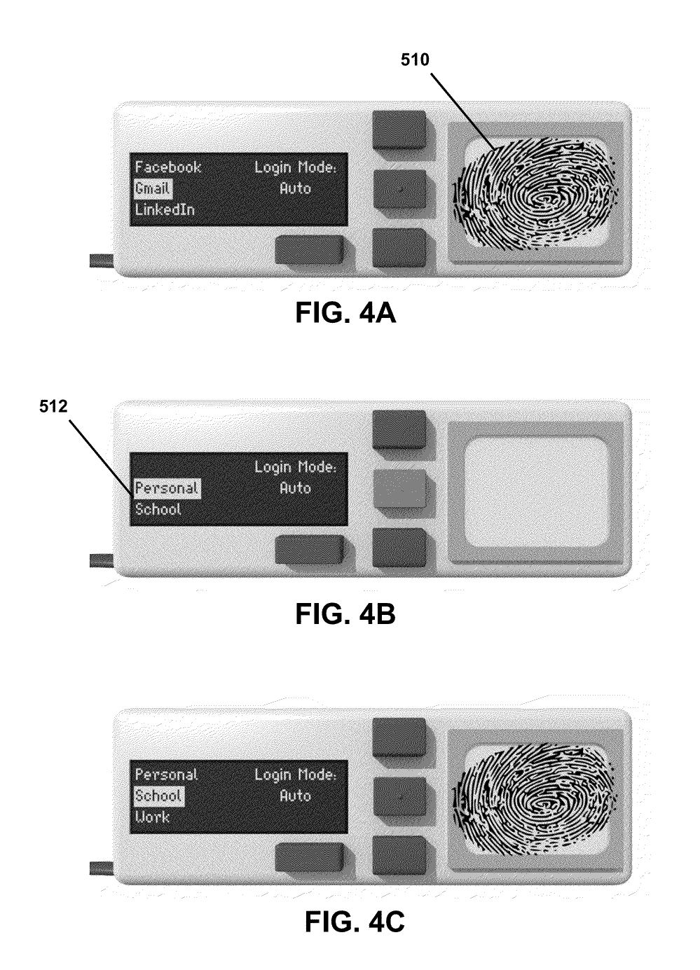

In reference to FIGS. 4A-C, there is shown a process of inputting fingerprint information. FIG. 4A shows a fingerprint impression 510 placed on and read by fingerprint scanner 422 after an account is chosen. FIG. 4B shows a successful access screen that is displayed if the input fingerprint matches saved fingerprint information. The successful access screen displays account types list 512 and allows a user to toggle with position toggle buttons 416, 418 and select the chosen account type with select button 420. As shown in FIG. 4C, once an account type is chosen, the user may re-place or re-swipe a finger on fingerprint scanner to input fingerprint information. If fingerprint information matches saved fingerprint information, the device outputs password and username information through the connector or interface.

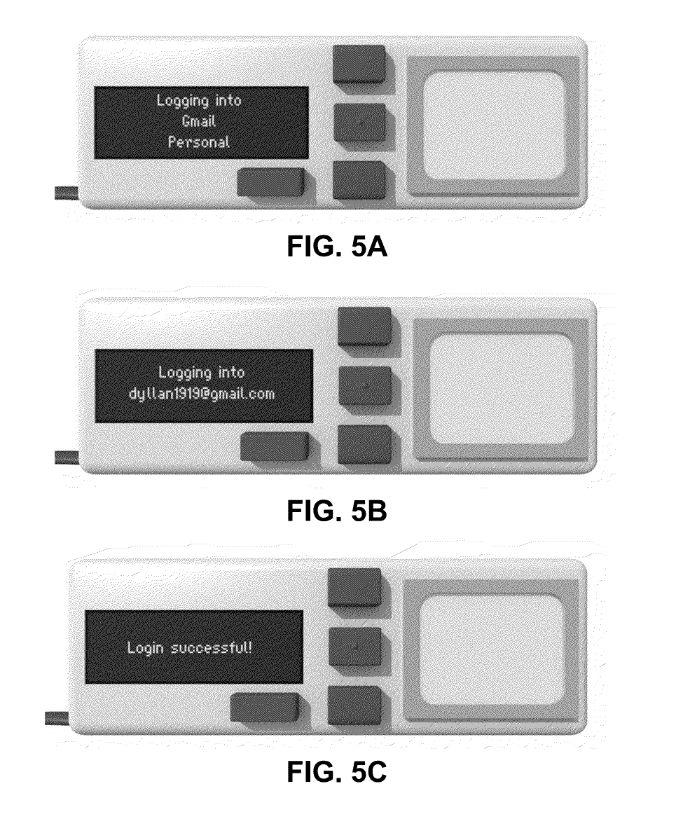

Referring to FIGS. 5A-C, there is shown a series of displays associated with a successful fingerprint match to saved fingerprint information. FIG. 5A shows a display presented as the device accesses username and password information, for a Gmail account, for example, from memory 230. FIG. 5B shows a display presented as the device inputs username and password information to an external electronic device 210 such as a personal computer. If the username and password input into external electronic device 210 with a graphical user interface requiring an ASCII-enterable username and password match a username and password combination stored within a database, the device displays a “Login Successful,” as shown in FIG. 5C.

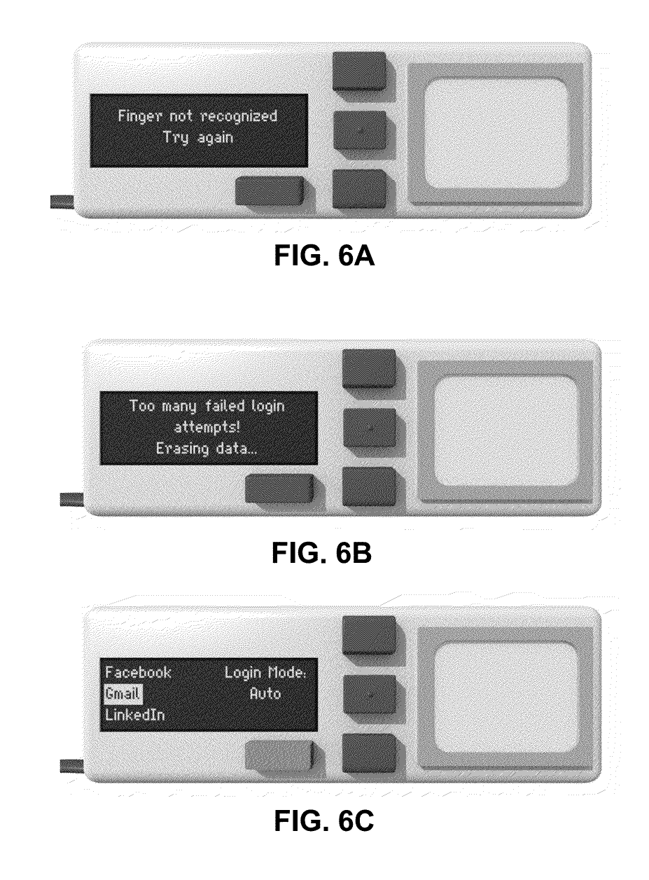

Referring to FIGS. 6A-C, there is shown a series of displays presented when a placed or swiped fingerprint does not match fingerprint information stored in memory 230. As shown in FIG. 6A, after a limited number of unsuccessful fingerprint matches, a user is prompted to try again. As shown in FIG. 6B, if the number of attempts exceeds a certain number, the apparatus may delete stored account or login information to prevent unauthorized access to accounts. FIG. 6C shows home screen 428 displayed after an unsuccessful fingerprint match attempt.

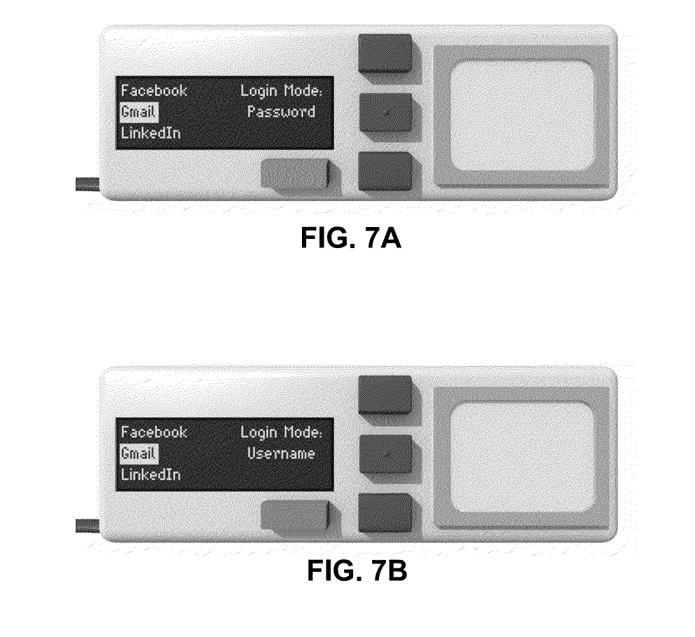

Referring to FIGS. 7A and 7B, there are shown two exemplary Login Modes. Login mode toggle button may be pressed to toggle through potential Login Modes. FIG. 7A shows an exemplary display of a Password Login Mode home screen 428. In a Password Login Mode, the apparatus of the present disclosure may only input a password. FIG. 7A shows an exemplary display of a Username Login Mode home screen 428. In Username Login mode, the apparatus of the present disclosure may only input a username.

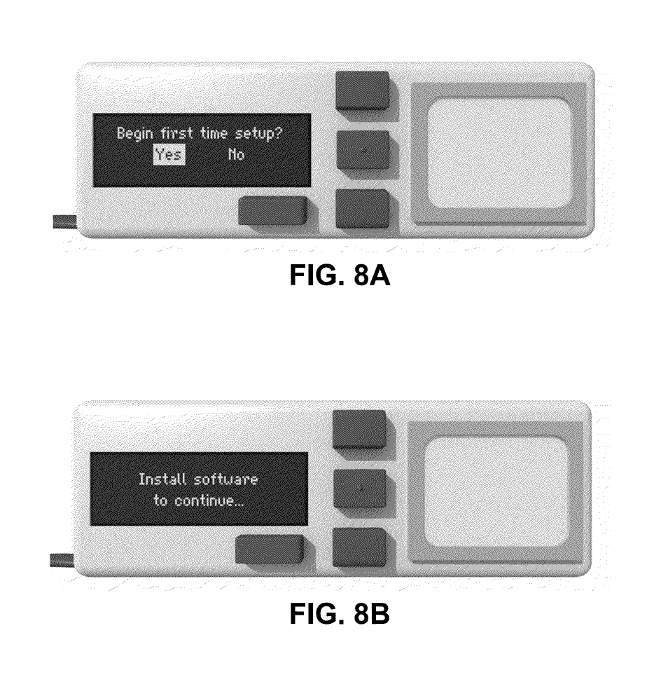

Referring to FIGS. 8A and 8B, there is shown an initial setup that may occur when an empty memory device, such a clean MicroSD card, is connected to the portable electronic apparatus. FIG. 8A shows a display screen requiring a user to select whether the user would like to go through a first-time setup process. The user may use the toggle buttons to choose “yes” or “no” and the select button to select the option. FIG. 8B shows the result of a “yes” selection. In FIG. 8B, the display displays a prompt to install software associated with running the apparatus of the present disclosure. Installation of software may occur through upload from a device connected to the portable electronic apparatus through I/O connector or interface, for example, a USB connector or interface.

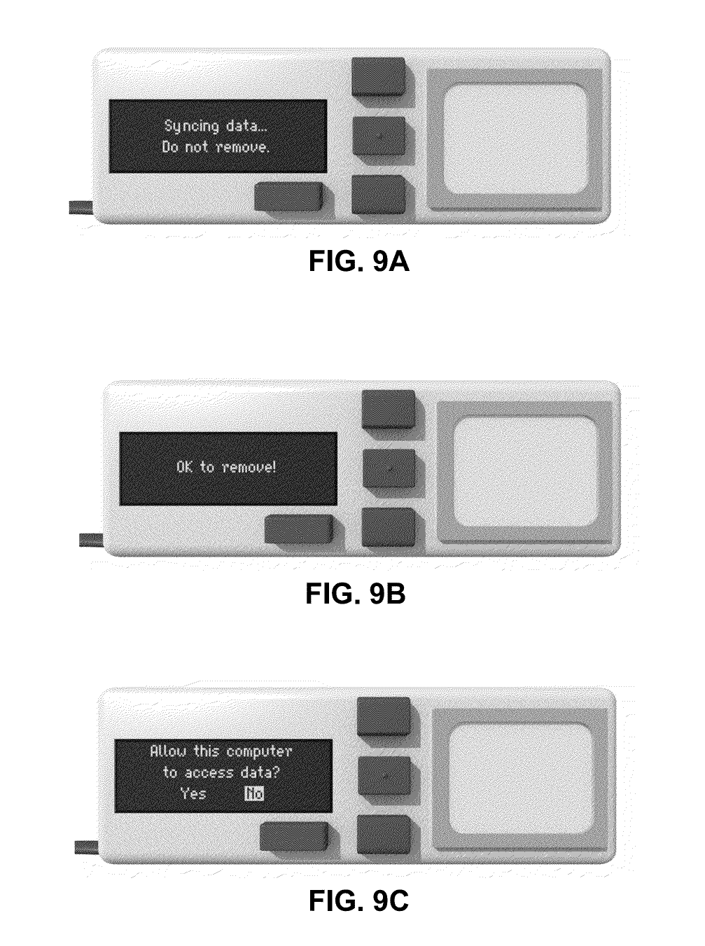

Referring to FIGS. 9A-C, there is shown a series of displays shown on the portable electronic apparatus while data is uploaded from external electronic device 210 to portable electronic apparatus 220. As shown in FIG. 9A, while data is uploaded to apparatus 220, apparatus 220 displays an instruction not to remove the apparatus from external electronic device 210 and informs users that data is being uploaded. When data upload has completed, apparatus 220 displays on display 428 information stating that it is safe to remove the portable electronic apparatus from the external electronic device, as shown in FIG. 9B. Apparatus 220 further prompts a user to determine whether to allow the formerly connected external electronic device 210 to access the uploaded data from apparatus 220, as shown in FIG. 9C. A user may toggle through “yes” and “no” options using toggle buttons 416, 418 and select an option using select button 420.

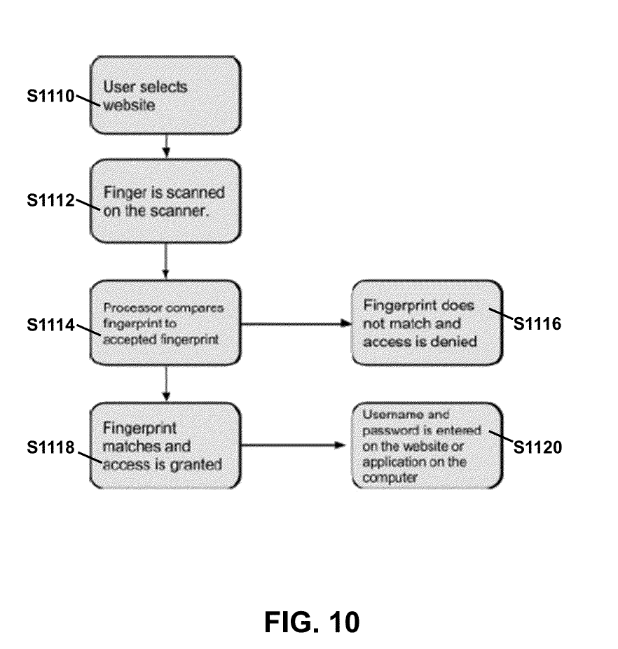

Referring to FIG. 10, there is shown a flow diagram of a user interact consistent with the present disclosure. In step S1110, a user may use external electronic device 210 to browse, as in with a software browser, to a graphical user interface requiring an ASCII-enterable username and password, e.g., a web-based email service. In step S1112, the user may place or swipe a finger on fingerprint scanner, in order to input fingerprint information. In step S1114, the processor compares the placed or swiped fingerprint to fingerprint information recorded on the microSD card. In step S1116, if the fingerprint does not match fingerprint information recorded on the microSD card, the user is denied access to username and password information stored within the microSD card. In step S1118, if the fingerprint matches fingerprint information recorded on the microSD card, the user is granted access to username and password information stored on the microSD card, and the username and password information is entered in the ASCII entry fields of a website or application running on the external electronic device in step S1120.

What is claimed is:

1. A method of accessing an account presented by a first electronic device, the method comprising:
coupling a second electronic device to the first electronic device;
selecting, at the second electronic device, the account;
obtaining, at the second electronic device, second biometric information;
comparing first biometric information with the second biometric information; and
if the first biometric information matches the second biometric information, populating, by the second electronic device, account information fields of the account presented by the first electronic device with account information stored in the second electronic device via a data input interface of the first electronic device.

2. The method according to claim 1, further comprising:
receiving, at the second electronic device, first biometric information; and
storing, at the second electronic device, the first biometric information in association with the account information.

3. The method according to claim 1, wherein the first and second biometric information is first and second fingerprint information, and
wherein obtaining the first and second biometric information includes scanning fingerprints to obtain the first and second fingerprint information.

4. The method according to claim 1, wherein the first and second biometric information is first and second voice information, and
wherein obtaining the first and second biometric information includes recording voice to obtain the voice first and second voice information.

5. The method according to claim 1, wherein the second electronic device is a USB electronic device, and
wherein the data input interface is a keyboard interface.

6. The method according to claim 1, wherein the first biometric information is associated with a plurality of different account information for different respective accounts.

7. The method according to claim 1, further comprising if the first biometric information does not match the second biometric information, generating an error message.

8. The method according to claim 1, further comprising:
encrypting the account information;
storing the encrypted account information in association with the first biometric information; and
if the first biometric information matches the second biometric information, decrypting the encrypted account information associated with the first biometric information and populating, by the second electronic device, the account information fields of the account with the decrypted account information.

9. The method according to claim 1, further comprising:
generating, at the second electronic device, random account information; and
associating the random account information with the first biometric information.

10. The method according to claim 1, further comprising storing, at the second electronic device, a plurality of fingerprints in association with account information for a respective plurality of accounts.

11. The method according to claim 1, wherein the account information is a username, a password, or a username and a password.

12. A portable electronic apparatus comprising:
a memory configured to store first fingerprint information in association with account information;
a fingerprint scanner configured to scan a fingerprint to obtain second fingerprint information;
an interface adapted to communicate with a keyboard interface of another electronic device; and
a processor in communication with the memory, the fingerprint scanner, and the interface, the processor configured to:
compare the first fingerprint information with the second fingerprint information; and
if the first fingerprint information matches the second fingerprint information, populate at least one account information field with the account information via the keyboard interface of the another electronic device.

13. The portable electronic apparatus according to claim 12, wherein the interface is a USB interface, a headphone jack, or a micro-USB interface.

14. The portable electronic apparatus according to claim 12, further comprising an input device configured to receive user selection of the account.

15. The portable electronic apparatus according to claim 14, further comprising a display in communication with the processor,
wherein the processor is configured to display the user selection of the account.

16. The portable electronic apparatus according to claim 14, wherein the input device is at least one button or a scroll wheel for scrolling through accounts.

17. The portable electronic apparatus according to claim 12, wherein the first fingerprint information is associated with a plurality of different account information.

18. The portable electronic apparatus according to claim 12, wherein the processor is further configured to:
encrypt the account information;
store the encrypted account information in association with the first fingerprint information; and
if the first fingerprint information matches the second fingerprint information, decrypt the encrypted account information associated with the first fingerprint information and populate the account information fields of the account with the decrypted account information.

19. The portable electronic apparatus according to claim 12, wherein the memory stores a plurality of fingerprint information for a respective plurality of fingers in association with a respective plurality of accounts.

20. The portable electronic apparatus according to claim 12, wherein the account information is a username, a password, or a username and a password.
